(19) United States
(12) Patent Application Publication
(10) Pub. No.: US 2006/0119046 A1
(43) Pub. Date: Jun. 8, 2006

(54) Method for producing a shielding gasket

(76) Inventors: Helmut Kahl, Berlin (DE); Bernd Tiburtius, Kleinmachnow (DE)

Correspondence Address: ALTERA LAW GROUP, LLC, 6500 CITY WEST PARKWAY, SUITE 100, MINNEAPOLIS, MN, 55344-7704, US

(21) Appl. No.: 11/341,804

(22) Filed: Jan. 27, 2006

Related U.S. Application Data
(63) Continuation-in-part of application No. 11/070,416, filed on Mar. 2, 2005, now abandoned.
Application No. 11/070,416 is a continuation of application No. 10/451,589, filed on Jan. 20, 2004, now Pat. No. 6,891,103.

(30) Foreign Application Priority Data
Dec. 23, 2000 (DE) 100 64 968.8

(51) Int. Cl. F16J 15/16

(52) U.S. Cl. 277/300

(57) ABSTRACT

The invention relates to a method for producing an electromagnetic shielding gasket. The task is accomplished, according to the invention, through a method according to claim 1 as well as an electrical apparatus having a corresponding gasket according to claim 6. Advantageous further developments are described in the dependent claims. Method for producing an electromagnetic shielding gasket by means of a shielding substance that contains a silicone plastic mass, electrically-conducting components, and components that are expandable under the influence of heat, in which method the gasket compound is dispensed onto a housing and/or printed circuit board and/or housing parts, and after and/or during the dispensing is treated with heat, thereby obtaining its desired, predetermined expansion and/or shape.

### CROSS REFERENCES TO RELATED APPLICATIONS

The present application is a continuation-in-part of prior application Ser. No. 11/070,416 filed Mar. 30, 2005 (Kahl, et al., “Method for Producing a Shielding Gasket”), which is a continuation of application Ser. No. 10/451,589 filed Jan. 20, 2004 now U.S. Pat. No. 6,891,103, (Kahl, et al., “Method for Producing a Shielding Gasket”), which is a 35 U.S.C. §371 filing from PCT/EP01/13777 filed Dec. 27, 2001, which is incorporated herein by reference thereto in its entirety, as though fully set forth herein.

### FIELD OF THE INVENTION

The invention relates to a method for producing an electromagnetic shielding gasket.

### BACKGROUND

Electromagnetic shielding gaskets as well as methods for their production have long been known. In this connection, reference is made to the different applications of the present applicant as well as to the publications cited in the examination process relating to these applications.

Further, reference is made to the European patent application EP 0 779 629 A2. This application describes an electrically conducting composite material that has a polytetrafluoroethylene matrix as well as electrically conducting components and additional hollow polymer components that are expandable under the influence of heat. Also stated there is that the electrically conducting composite is to contain in addition an elastomeric material, which can consist of a silicone material. Although known from the above-named publication is the application of the material described and claimed there for the production of an electromagnetic shielding gasket, nevertheless it is very difficult, using the object described in EP 0 779 629 A2, to produce a shielding gasket, particularly when the external tolerances are extremely small, for example in the range of a few millimeters of diameter.

The invention is based on the object of avoiding the disadvantages of the shielding gasket and of its production as known from EP 0 770 629 A2.

Advantageous embodiments are described in the dependent claims.

If the shielding substance is dispensed onto a foil the shielding gasket can be produced as a separate part. The separate shielding gasket can be attached to a housing and/or printed circuit board and/or housing parts in a subsequent production step. Separate shielding gaskets can be particularly advantageous if the shielding gasket is a spare part which is used to replace shielding gaskets that have been damaged upon disassembly of a housing.

The shielding gasket can be disposed onto the housing while the gasket is still attached to the foil. In this case the foil can be glued or otherwise adhered to the housing. It is also possible to separate the gasket from the foil and dispose the gasket into a groove of the housing.

According to another aspect of the invention the silicone plastic mass is hardened in a first step, and the heat treatment is applied in a second step after the silicone plastic mass has been hardened. The expansion of the expandable components exerts a pressure force onto the hardened silicone plastic mass and thereby improves the conductivity between the electrically conducting components within the silicone plastic mass.

According to still another aspect of the invention the shielding substance is used for producing an electromagnetically shielded housing. The at least two parts of the housing are placed in a final position relative to each other before the shielding substance is expanded. After heat treatment and expansion the shielding substance exerts a pressure force to the housing parts. This pressure force improves the mechanical as well as the electromagnetical sealing effect of the shielding gasket. By means of the inventive method a shielding gasket can also be produced if the gap between the housing parts is of irregular dimension.

The inventive shielding gasket generally is especially advantageous if it is used in a high temperature environment. Known shielding materials tend to experience compression set after exposure to heat. The compression set has a detrimental effect on the shielding and sealing properties of shielding materials because the pressure force between the shielding material and adjacent surfaces is reduced. The inventive shielding material which comprises expandable components is not subject to compression set after heat treatment. In contrast, the expanded components even expand further in a high temperature environment and thereby increase the pressure force between the shielding substance and adjacent surfaces.

The essential difference between the present invention and the prior art according to EP 0 779 629 A2 consists in the fact that, in the invention, no polytetrafluoroethylene matrix is necessary for the construction of the shielding gasket. Rather, the electrical shielding gasket is produced through the dispensing of a shielding substance and a subsequent heat treatment of the dispensed compound, the heat treatment taking place until the dispensed compound obtains its predetermined expansion or form.

The shielding substance contains electrically conducting components, for example silver particle, coal, metallic powder, etc., as well as expandable components, preferably expandable polymeric hollow spheres as well as silicone plastic.

The production of a dispensed shielding gasket is considerably more convenient and simple than is the production of a gasket as known from EP 0 779 629 A2.

### SUMMARY

In the method according to the invention, dispensing devices can be used for the dispensed application of the shielding substance and, after the dispensing, the heat treatment can take place either directly during the dispensing process or subsequently thereto in a heating chamber.

### BRIEF DESCRIPTION OF THE DRAWINGS

FIG. 1a illustrates a shielding substance in the presence of a guiding wall, before expansion.

FIG. 1b illustrates a shielding substance in the presence of a guiding wall, after expansion.

FIG. 2a illustrates a gasket in the presence of multiple guiding walls, before expansion.

FIG. 2b illustrates a gasket in the presence of multiple guiding walls, before expansion.

FIG. 2c illustrates a gasket in the presence of multiple guiding walls, after expansion.

FIG. 3 illustrates a gasket forming a varying profile in response to a locally varying heat source.

FIG. 4 illustrates a stamped gasket formed by a prior art method.

FIG. 5 illustrates a dispensed gasket in accordance with the present embodiment.

FIG. 6a illustrates a shielding substance dispensed as multiple, relatively small beads.

FIG. 6b illustrates a shielding substance dispensed as multiple, relatively large beads.

### DETAILED DESCRIPTION

The micro hollow spheres can, for example, be such as are available from the firm Nobel Industries of Sundsvall, Sweden under the trade names “Expanal”. Such micro hollow spheres can be obtained in a great variability of size and form with an expansion temperature lying primarily in the range between 70 and 130.degree. C. A typical Expanal micro hollow sphere has an initial-diameter dimension (i.e. not yet expanded) of 9 to 17 μm and, on average, an expanded diameter of 40 to 60 μm. Accordingly, the cubic-meter weight of the micro hollow spheres in the unexpanded state is approximately 1250 to 1300 kg/m³, and in the expanded state approximately 20 to 30 kg/m³.

In particular when the heat treatment takes place during the dispensing process of the shielding substance or shortly thereafter, it is possible to produce a large number of shielding gaskets within the shortest period of time in a simple manner, in which the dispensing robot, by means of which the shielding substance is applied to a housing, printed circuit board, or housing part, can easily adjust the dispensed application to the demands on the housing in each case. Also, such dispensing devices can be provided in a simple manner with a heat-generating apparatus, for example an infrared-radiation unit or a laser or another apparatus for heat generation, so that the expandable micro hollow spheres can expand.

The duration of the heat treatment is dependent on how far the dispensed shielding substance is to expand and what shape it must assume in the process.

After the heat treatment, the diameter of the shielding substance, which is applied, for example, as a bead or beads, is distinctly greater than prior to the heat treatment. The diameter expansion or widening of the diameter can be adjusted through the temperature and/or duration of the heat treatment such that the desired degree of expansion is achieved.

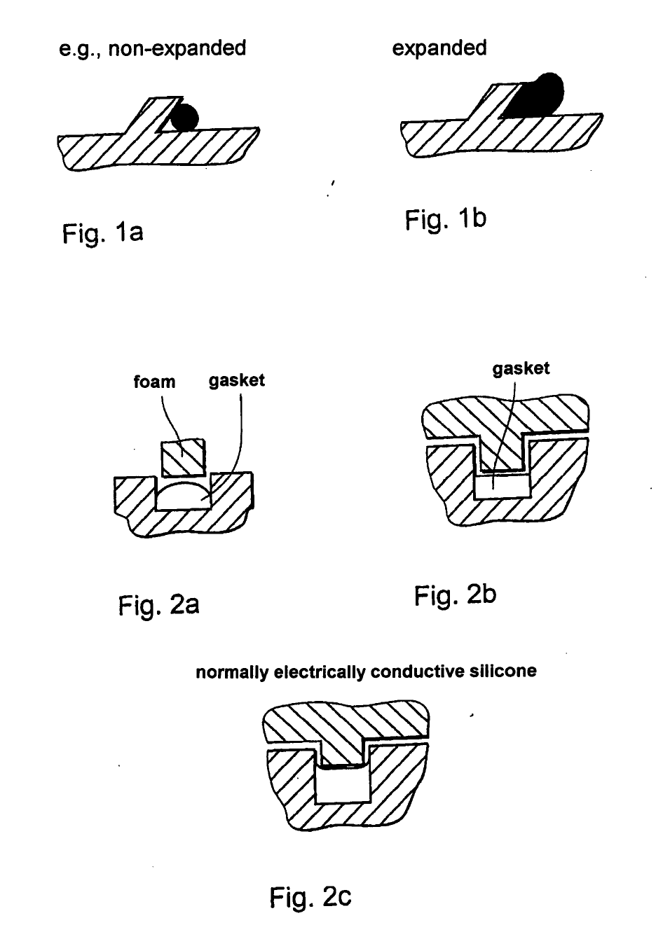

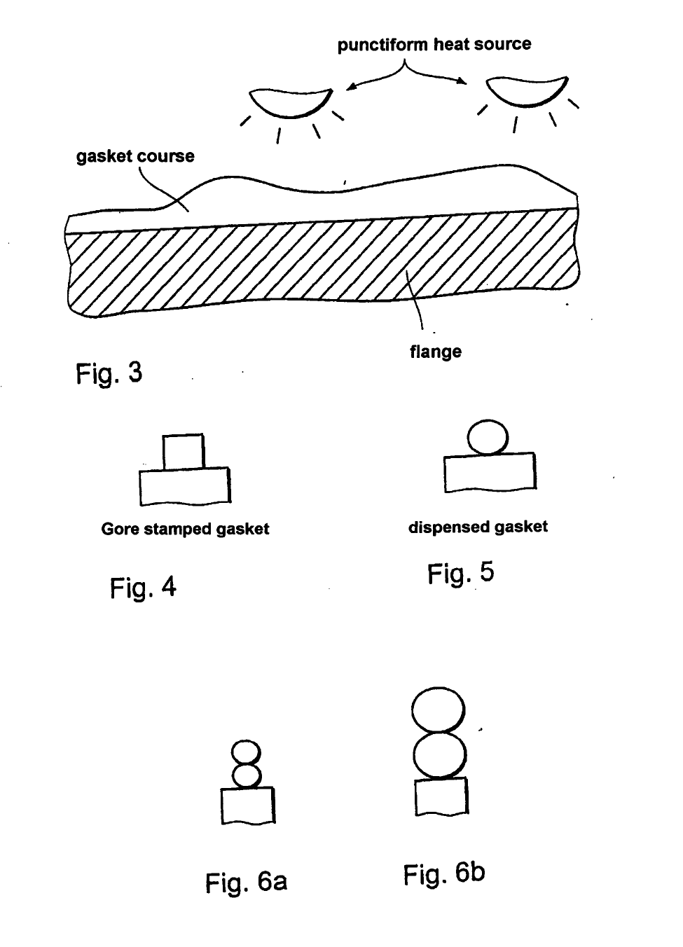

In particular when the dispensed application is not sufficient when using a conventional dispensed bead, for example, because the dispensed bead cannot completely bridge the gap between two housing parts, the use of the solution according to the invention is very expedient and cost-effective. The gasket according to the invention is especially suitable for waterproof sealing, whether for spray or even pressurized water. Also, it is possible to construct so-called “guide walls”, i.e. arranging crosspieces and flanges such that when an expansion occurs, the direction and/or form is roughly predetermined. Examples of this are represented in FIGS. 1, 2, 3, and 6.

The proportion of silicone (rubber) in the shielding substance can lie in the range between 20 and 70%, the proportion of the electrically conducting components in the range between 20 and 80% by volume (according to the fill material) of the output material, and the proportion of the micro hollow spheres in the range between approximately 1 and 25% by volume of the output material.

After the heat treatment the hardness grade (according to Shore A) of the shielding gasket according to the invention amounts to approximately 15 to 85; the proper hardness grade can be determined through selection of an appropriate plastic or duration of the heat treatment.

The absolute diameter of the shielding gasket can lie in the range of less than 1 mm to 30 mm.

The heat treatment for expansion of the entire shielding substance on the basis of the simultaneous expansion of the micro hollow spheres can also take place after the dispensing of the shielding substance and after the assembly of the housing, for example in a heat oven. Since the temperatures of the heat treatment are still relatively low and normally cause no destruction of the housing or housing part, such a treatment of the already-assembled housing results in the fact that through the expansion of the shielding substance, the latter is precisely distributed in the entire housing or in the gap between the adjacent housing parts, thus closing and sealing the housing such that electromagnetic radiation can no longer penetrate into the housing or escape from it. Moreover, at the same time an outstanding mechanical seal against moisture, liquid, or other objects such as dust is achieved.

After the expansion process, the shielding gasket is, as before, still elastic and even multiple openings and closings of the housing and the reassembly of housing parts is readily possible without causing damage to the corresponding shielding substance or significantly affecting the functionality of the shielding substance.

The heat treatment described in the present application can be carried out by means of a heated needle or nozzles or, if the gasket is already situated on a part, a simple heat aftertreatment can also be carried out. It is also possible, using the method according to the invention, to produce an electrically conducting foam, which can be dispensed onto a foil, for example.

The essential difference between the method according to the invention and the proposal according to EP 0 779 629—FIG. 4—consists also in the fact that the known production method according to EP 0 779 629 requires six productions steps and is therefore very expensive. Essentially, the six production steps are drying (after the mixing), freezing, grinding up, extruding, pressing, and then applying to a foil, e.g. a telephone part. In the method according to the invention, in contrast, only the production steps mixing, applying, and expanding are required.

In comparison to PTFE (polytetrafluoroethylene), as disclosed in EP 0 79 629, silicone has a considerably better compression set value. In general, dispensed gaskets (see FIG. 5) also require lower pressing forces for deformation.

While according to the cited EP 0 779 629 silicone polymers are described as an admixture to the PTFE (polytetrafluoroethylene) mass, the electrically-conducting PTFE compounds also containing an elastomer, and in the production the individual components are mixed, dried (at 105.degree. C. for 24 hours) and/or deep-frozen (−10.degree. C. for 6 hours), sieved, diluted, stored at room temperature, extruded, dried, and expanded, the method according to the invention requires merely a mixing and the filling into cartridges of the gasket components according to the invention, and subsequently an application of the gasket, for example by means of dispensing using needles and nozzles, can take place. The expansion of the shielding substance through heat can occur either through a heating of the needle (nozzle) itself or the heat is applied after the application of the gasket.

Preferably, in the method according to the invention, after the dispensing a gasket with a semicircular cross section is present, which reduces the force necessary to deform the gasket later.

It is also important to state that in the method according to the invention the final shape of the gasket is, in all essentials, determined by the type and/or amount of the applied heat. In contrast to this, known from WO 98/08365 is a method in which the final gasket shape (in particular with respect to its cross section) is determined through the needle diameter (nozzle diameter), the application speed, or though the composition of the compound (viscosity, thixotropy, etc.) and/or through the application apparatus. Moreover, although the treatment of gaskets with heat after their application was previously generally known, this heat treatment nevertheless served only the purpose of cross-linking, drying, or hardening the silicone polymers, and had nothing to do with the concrete formation of the cross-sectional shape of the gaskets. The determination of the expansion and/or the shape of the shielding gasket in dependence on the concrete application of heat is the particular knowledge of the present invention and facilitates the production of an electromagnetic shielding gasket in particular application forms and, in comparison to the known solutions, makes this production more cost-efficient.

We claim:

1. A method for producing an electromagnetic shielding gasket by means of a shielding substance that contains a silicone plastic mass, electrically-conducting components, and components that are expandable under the influence of heat, in which method the gasket substance is dispensed onto a foil, and after and/or during the dispensing is treated with heat, thereby obtaining its desired, predetermined expansion and/or shape.

2. The method of claim 1, wherein the foil and the shielding gasket which is attached to the foil are disposed onto a housing and/or printed circuit board and/or housing parts.

3. The method of claim 1, wherein the shielding gasket is separated from the foil and wherein the shielding gasket is disposed onto a housing and/or printed circuit board and/or housing parts.

4. The method of claim 1, wherein the expandable particles, in the non-expanded state, have a diameter that is substantially in the range of 2 to 50 μm, and in the expanded state a diameter that is substantially in the range of approximately 30 to 200 μm.

5. The method of claim 1 wherein the expandable components are micro spheres or micro hollow spheres consisting of a polymer or another plastic, which spheres are electrically nonconductive and, through heat treatment, are enlargeable in size by a factor of approximately 5 to 70 in volume.

6. The method of claim 1, wherein during the heat treatment the temperature of the shielding substance lies approximately in the range of 50° C. to 140° C.

7. The method of claim 1, wherein after the dispensing and after the heat treatment the shielding substance is essentially circular in cross section (bead, double bead).

8. The method of claim 1, wherein means are provided whereby the expansion is guided into a direction and/or shape that is associated with the purpose and/or is appropriate.

9. The method of claim 1, wherein the expanded shielding substance undergoes locally a different (partial) heat treatment, in order to achieve targeted, different heights and/or widths of the expanded shielding substance and to lower the possible physical deformation forces.

10. A method for producing an electromagnetic shielding gasket by means of a shielding substance that contains a silicone plastic mass, electrically-conducting components, and components that are expandable under the influence of heat, in which method the gasket substance is dispensed onto a housing and/or printed circuit board and/or housing parts, and the silicone plastic mass is hardened after dispensing, and the shielding substance is treated with heat after hardening of the silicone plastic mass, thereby expanding the expandable components.

11. The method of claim 10, wherein the expandable particles, in the non-expanded state, have a diameter that is substantially in the range of 2 to 50 μm, and in the expanded state a diameter that is substantially in the range of approximately 30 to 200 μm.

12. The method of claim 10 wherein the expandable components are micro spheres or micro hollow spheres consisting of a polymer or another plastic, which spheres are electrically nonconductive and, through heat treatment, are enlargeable in size by a factor of approximately 5 to 70 in volume.

13. The method of claim 10, wherein during the heat treatment the temperature of the shielding substance lies approximately in the range of 50° C. to 140° C.

14. The method of claim 10, wherein after the dispensing and after the heat treatment the shielding substance is essentially circular in cross section (bead, double bead).

15. The method of claim 10, wherein means are provided whereby the expansion is guided into a direction and/or shape that is associated with the purpose and/or is appropriate.

16. The method of claims 10, wherein the expanded shielding substance undergoes locally a different (partial) heat treatment, in order to achieve targeted, different heights and/or widths of the expanded shielding substance and to lower the possible physical deformation forces.

17. A method for producing an electromagnetically shielded housing, wherein the housing comprises at least two housing parts forming a gap between adjacent portions of the housing parts, comprising the steps of:
a) dispensing an electromagnetic shielding substance that contains a silicone plastic mass, electrically-conducting components, and components that are expandable under the influence of heat onto adjacent portions of at least one of the housing parts;
b) disposing the housing parts in a final position relative to each other; and
c) treating the shielding substance with heat, thereby expanding the shielding substance.

18. The method of claim 17, wherein the gap is of irregular diameter.

19. The method of claim 17, wherein the expandable particles, in the non-expanded state, have a diameter that is substantially in the range of 2 to 50 μm, and in the expanded state a diameter that is substantially in the range of approximately 30 to 200 μm.

20. The method of claim 17, wherein the expandable components are micro spheres or micro hollow spheres consisting of a polymer or another plastic, which spheres are electrically nonconductive and, through heat treatment, are enlargeable in size by a factor of approximately 5 to 70 in volume.

21. The method of claim 17, wherein during the heat treatment the temperature of the shielding substance lies approximately in the range of 50° C. to 140° C.

22. The method of claim 17, wherein after the dispensing and after the heat treatment the shielding substance is essentially circular in cross section (bead, double bead).

23. The method of claims 17, wherein means are provided whereby the expansion is guided into a direction and/or shape that is associated with the purpose and/or is appropriate.

24. The method of claims 17, wherein the expanded shielding substance undergoes locally a different (partial) heat treatment, in order to achieve targeted, different heights and/or widths of the expanded shielding substance and to lower the possible physical deformation forces.
